(19) United States
(12) Patent Application Publication
(10) Pub. No.: US 2011/0169241 A1
(43) Pub. Date: Jul. 14, 2011

(54) DRIVER CONTROLLED SUSPENSION GEOMETRY

(76) Inventor: Mark A. SHERIFF, Kanappolis, NC (US)

(21) Appl. No.: 13/006,095

(22) Filed: Jan. 13, 2011

Related U.S. Application Data
(60) Provisional application No. 61/294,706, filed on Jan. 13, 2010.

(51) Int. Cl. B60G 9/02

(52) U.S. Cl. 280/124.117

(57) ABSTRACT

A method for altering the rear suspension angles of a vehicle. In one embodiment, the method comprises comprise an extendable rod end coupled to the body of the vehicle and the suspension of the vehicle.

### CROSS-REFERENCE TO RELATED APPLICATIONS

This application claims benefit under 35 USC §119 of U.S. provisional application No. 61/294,706 filed Jan. 13, 2010, entitled “Driver Controlled Suspension Geometry” which is hereby incorporated herein by reference in its entirety for all purposes.

### STATEMENT REGARDING FEDERALLY SPONSORED RESEARCH OR DEVELOPMENT

Not applicable.

### BACKGROUND

1. Field of the Invention

This invention relates altering vehicles' suspension, specifically to changing the rear suspension geometry from the cockpit.

2. Background of the Invention

In conventional automotive and truck travel, the ability to turn through a corner at speed is mechanically limited by the steering angle of the front wheels, the wheelbase, and the alignment of the suspension. In performance and racing applications, this mechanical interference reduces cornering performance and increases lap times, particularly for vehicles involved in dirt track racing, asphalt track racing, and road racing. Additionally, altering a suspension geometry prior to competition may interfere with changing conditions, driver preference, or represent a compromised setup incapable of delivering maximal performance during other maneuvers.

As such, there is need for a driver controlled means to alter the suspension geometry of a vehicle to improve cornering performance.

### BRIEF SUMMARY

An vehicle suspension system comprising a driver interface; a rear suspension; and an extendable apparatus coupled to the rear suspension system and body of a vehicle, the apparatus configured to alter the rear suspension geometry in relation to the automobile.

An extendable rod end comprising; a first end, having a spherical bearing configured for mounting to an automotive body; a second end, having a spherical bearing configured for mounting to an automotive rear suspension; a extendable body positioned between the first end and the second end, configured for changing the distance along an axis between the first end and the second; and a control system, in communication with an operator and the extendable body to move the extendable body in relation to operator commands.

The embodiments described herein comprise a combination of features and advantages intended to address various shortcomings associated with certain prior devices. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a detailed description of the preferred embodiments of the invention, reference will now be made to the accompanying drawings in which:

FIG. 1 illustrates a schematic according to one embodiment of the disclosure;

FIG. 2 illustrates an extendable rod end according to one embodiment of the disclosure

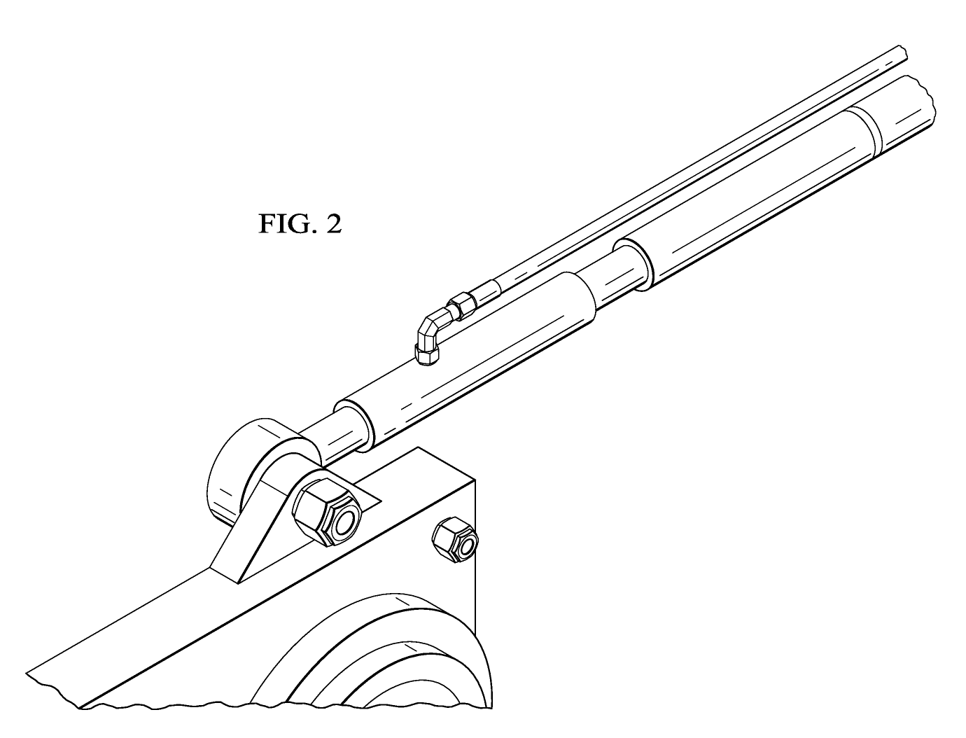

FIG. 3 illustrates a driver interface according to one embodiment of the disclosure;

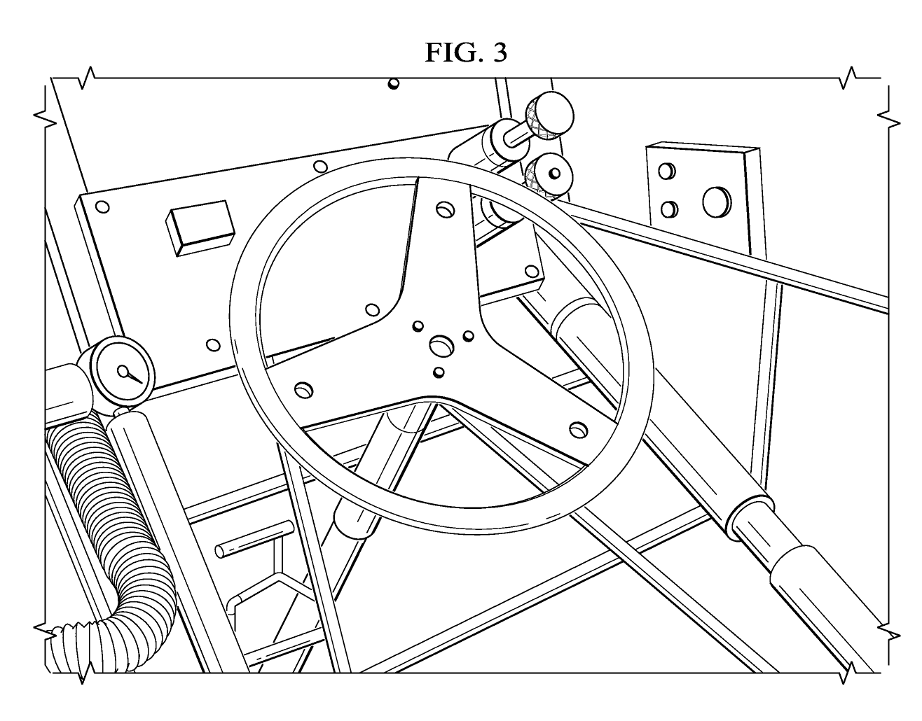

FIG. 4 illustrates a schematic according to one embodiment of the disclosure.

### DETAILED DESCRIPTION OF THE PREFERRED EMBODIMENTS

A means of altering the rear suspension geometry of a vehicle comprises a mechanically moveable rod end, or extendable rod ends. The rod ends are positioned at opposing ends of an extendable actuator. The actuator may be any actuator, including but not limited to a hydraulic piston, a pneumatic actuator, an electric actuator, or geared actuator, such as rack and pinion or worm gear actuator. A first end of the extendable rod ends is coupled to the frame or body of the vehicle. The second end of the extendable rod ends is coupled to the suspension, axle, knuckle, bearing carrier, or hub of the rear suspension. Further, the extendable rod end is in communication with a driver interface positioned in the cabin or cockpit of the vehicle. The driver interface comprises any device configurable for communicating driver's inputs to the extendable rod ends.

In certain instances, the extendable rod ends extend and retract in a coordinated manner to alter the rear suspension geometry. More specifically, the extendable rod ends extend and retract in a coordinated manner to alter the rear suspension in relation to the body and frame of the vehicle. In certain configurations, the rod ends are configured to pivot the rear suspension horizontally in relation to the longitudinal axis L_{A} of the vehicle. Pivoting the rear suspension geometry moves the axis of rotation A_{R}, or the axis about which a vehicle turns along the longitudinal axis L_{A} of the vehicle. Without limitation by theory, in a conventional vehicle the axis of rotation A_{R} for a turn is positioned approximately between the rear wheels. In certain instances, the rear suspension geometry is pivoted in the opposite direction of the front wheels, thereby moving the axis of rotation A_{R} closer to the center point CP of the vehicle, increasing the rotation and rotational moment of the vehicle. Alternatively, the rear suspension geometry is configured to pivot in the same direction as the front wheels, thereby moving the axis of rotation A_{R} further from the center point of the vehicle behind the rear wheels. In certain instances, the rod ends are configured to pivot the rear suspension vertically, in relation to the ground, the drive line or driveshaft, or in relation to the position of the engine. Further, pivoting the rear suspension vertically alters the driveline angle in relation to the rear suspension or rear axles. Without limitation by theory, altering the driveline angle vertically in relation to the rear suspension alters driveline rotational play, mechanical grip, handling, and traction. In certain instances, the angle of the rear suspension 15 with respect to the longitudinal axis L_{A} comprises the drive angle. Further, the angle of the rear suspension in relationship the driveshaft comprises a pinion angle.

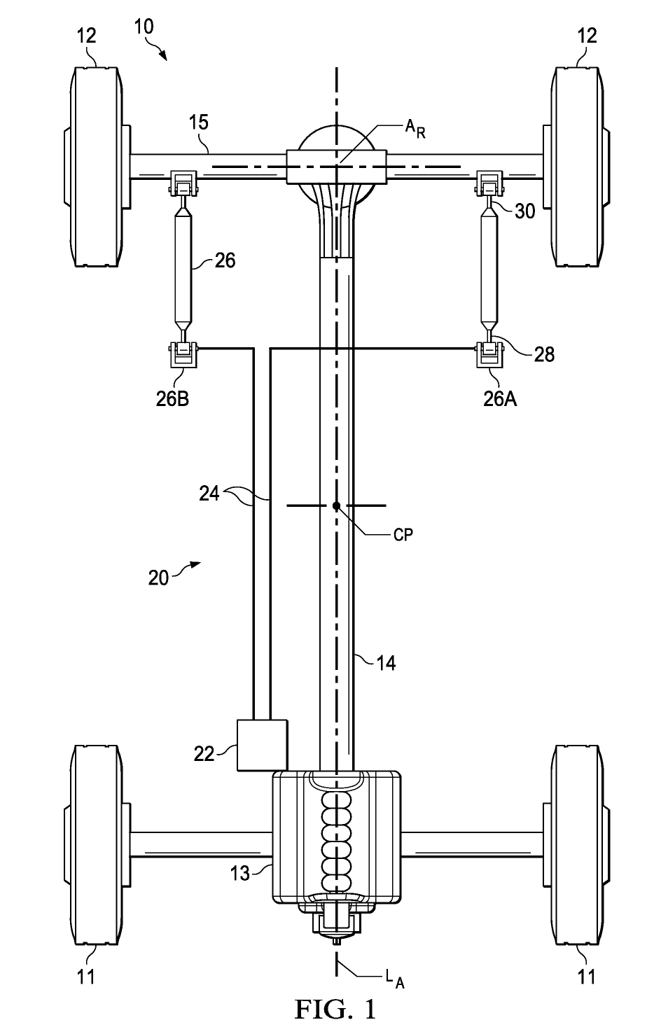

Referring now to FIG. 1, illustrating a top view of a vehicle chassis 10, including front wheels 11, rear wheels 12, engine 13, driveshaft 14, and rear suspension 15. The system 20 comprises driver interface 22, communication 24, and extendable rod ends 26. In instances there may be a left (driver side) rod end 26A and a right (passenger side) rod end 26B. Each rod end has a first end 28 coupled to the body or frame of the vehicle and a second end 30 coupled to the rear suspension 15.

Driver interface 22 comprises a driver control. Driver interface 22 is positioned in the cockpit or cabin of a vehicle. The driver interface 22 may be positioned on the steering wheel, the control panel, the safety roll cage, the doors, the driver seat, the floor, or the firewalls, without limitation. In certain instances the driver interface 22 is positioned on the control panel or a roll cage member and alternatively, on the steering wheel. Driver interface 22 is positioned anywhere within easy reach of a driver.

Driver interface 22 comprises any mechanical, electrical, or transmitter without limitation, for instance a hydraulic cylinder or pump, or an electrical switch. Alternatively, driver interface 22 comprises and electric switch configured for transmitting a signal. In instances, driver interface 22 is incremental, such as a dial, a slider, or any other control device with incremental states. Alternatively, the driver interface 22 is binary, having two states such as an on-off switch. Driver interface 22 comprises a hydraulic cylinder configured for moving a fluid in a hydraulic system.

Driver interface 22 is coupled to the extendable rod ends 26 by a communication 24. The communication 24 comprises hydraulic lines, electric wires, or mechanical couplers, such as linkages and rods, without limitation. In certain instances, the communication 24 comprises a short-range wireless transmission. Communication 24 is configured to operate extendable rod ends 26 in response to driver inputs by the driver interface 22.

Extendable rod ends 26 comprise at least one rod end, or spherical bearing, coupled to an extendable actuator. In stances, the rod ends comprise a first end 28 and a second end 30, that are both configured as a rod end. Without limitation, a rod end permits unlimited pivoting about one axis and limited pivoting about another.

In instances there is a left (driver side) rod end 26A and a right (passenger side) rod end 26B. Each extendable rod end 26 has a first end 28 coupled to the body or frame of the vehicle and a second end 30 coupled to the rear suspension 15. As may be understood by one skilled in the arts, the extendable rod ends 26 permit unlimited vertical suspension compliance, and limited compliance in relationship to one another, for instance in response to horizontal body roll. However, the extendable rod ends 26 maintain the driver determined linear relation ship between the rear suspension 15 and the body or frame of the vehicle along the longitudinal axis L_{A}.

In instances, the first end 28 may be consider the fixed end, wherein the first end 28 is coupled to the body or frame of the vehicle at one fixed location. The first end 28 has one position along the longitudinal axis L_{A} of the vehicle. The second end 30 coupled to the rear suspension is configured to extend or retract in relation to the first end 28 along the longitudinal axis L_{A} of the vehicle. The second end 30 coupled to the rear suspension 15 alters the geometry of the rear suspension, and more specifically the drive angle of the rear wheels. In certain instance, one rod end is configured to extend and the other is configured to retract, such that the rear suspension 15 is angled with respect the longitudinal axis L_{A} of the vehicle. For example in a left turn, the driver may select by the driver interface 22 to retract the left extendable rod end 26A and extend the right extendable rod end 26B.

In instances, the extendable rod ends 26 comprise an actuator configured for linear motion in at least one direction. The extendable rod ends 26 may comprise a hydraulic piston, a two chamber hydraulic, or the like, such that the extendable rod ends 26 extend in response to a fluid moving into a chamber, and retract in response to the fluid moving out of a chamber. In certain instance, the fluid may comprise air, for instance in a pneumatic system. In certain instances, the extendable rod end 26 comprises a two chamber hydraulic piston. Without limitation by theory, a two chamber hydraulic piston comprises a piston or ram that separates two chambers of hydraulic fluid. The piston is configurable for linear motion by the transfer of fluid from one chamber to the opposite chamber. As may be understood, the complete fluid volume in the chamber does not change as the piston is extended or refracted. Alternatively, the fluid volume of the chamber my increase as the piston is moved in extension, and decrease as the chamber is moved in retraction. In certain instances, the extendable rod ends 26 may include exterior reservoirs for holding fluid.

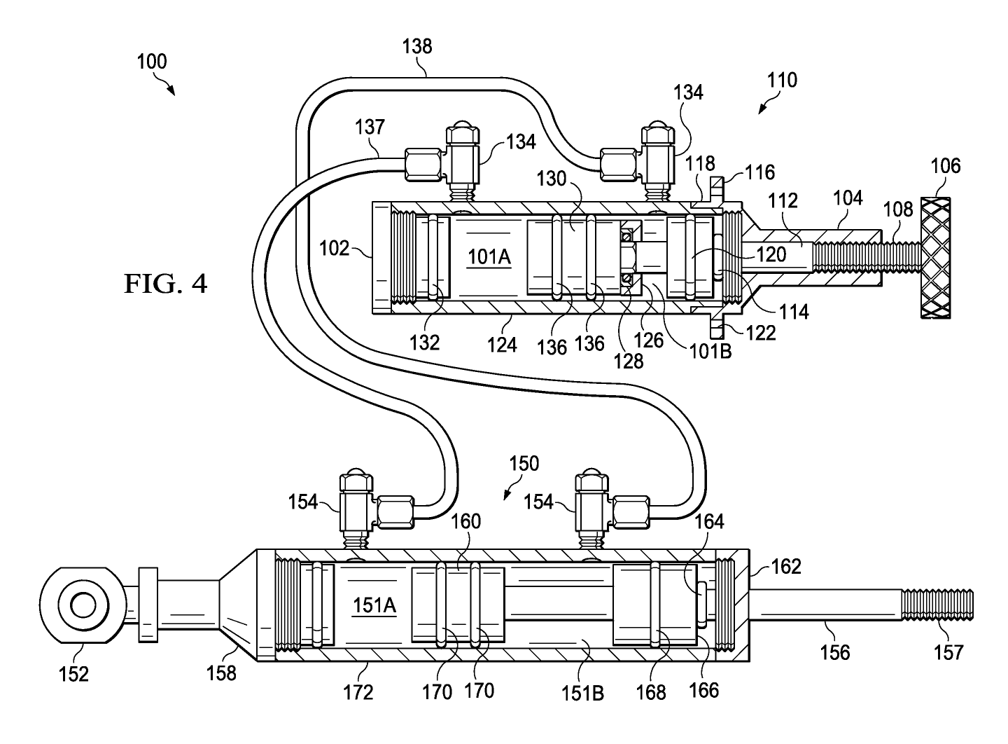

Referring now to FIG. 4, illustrating a cutaway schematic of the system 100 for altering suspension geometry. The system 100 comprises a hand crank 110 and adjustable shaft 150 coupled by hydraulic lines 138, 137. The hand crank 150 comprises a piston 130 and a shaft 112. Similarly, the adjustable shaft 150 comprises a piston 160 and a shaft 156. Without limitation by theory a skilled artisan will recognize that the movement of the piston 130 in the hand crank 110 will result in the movement of piston 160 in the adjustable shaft 150.

Referring now to the hand crank 110, the apparatus comprises a housing 124 having a piston 130 and shaft 112 disposed therein. A knob 106 is fixably coupled to the free end of the shaft 112. The housing 124 comprises at least two fluid chambers 101A and 101B, separated by the piston 130. The housing 124 comprises a housing end cap 102 and hand crank housing cap 116. The housing end cap 102 comprises end cap seal 132. Hand crank housing cap 116 comprises a threaded housing 104, shaft seal 114, housing seal shaft guide 118, a housing seal 120, and seal shaft guide 118. In certain instances, the hand crank housing cap 116 comprises at least one mounting hole 122. More specifically, the threaded housing 104 comprises threads or other means to engage the shaft 112 for movement of the piston 130 within the hand crank 110.

The shaft 112 extends from the knob 106, through the threaded housing 104 and into the fluid chamber 101, where it engages piston 130. Piston 130 comprises at least one piston seal 136. Piston seal 136 on piston 130 splits the fluid chamber into to portions 101A, 101B. Piston seal 136 isolates each fluid chamber 101A, 101B, from the other. In instances, piston seal 136 comprises a plurality of seals to maintain fluid pressure in each chamber, maintain separation of fluid chambers in case of a seal failure, and maintain operation of system 100 in case of seal failure or damage. In instances, shaft 112 comprises a bearing 128. The bearing 128 is retained to shaft 112 by any means known to a skilled artisan, for instance a nut or cotter pin. The bearing 128 interfaces with the piston 130 such that as the shaft 112 rotates in response to the knob 106, the piston 130 is isolated from rotational movement. Without limitation by theory, isolating piston 130 and piston seals 136 from rotational movement 136 may extend the operational lifetime of piston seals 136.

Housing 124 comprises hydraulic fitting 134. Hydraulic fitting 134 may comprise any fitting known to one skilled in the art, for example AN threaded fitting (e.g. “Army-Navy” standard fittings), SAE threaded fitting (Society of Automotive Engineers), or any other known to a skilled artisan. Hydraulic fitting 134 is threaded to a housing 124 and in fluid communication with fluid chamber 101. In certain instances, the housing 136 comprises a plurality of hydraulic fittings 136, in fluid communication with each fluid chamber 101A, 101B. Further, each hydraulic fitting 136 is in fluid communication with a hydraulic line 137, 138.

The hydraulic lines 137, 138 are in fluid communication with an adjustable shaft 150, via hydraulic fittings 154. In instances, adjustable shaft 150 is an extendable rod end. Adjustable shaft 150 comprises shaft housing 172, end housing and seal 158, rod end 152, piston 160, shaft 156, housing seal and shaft guide 166. Piston 160 divides the fluid chamber 151 into two portions 151A and 151B. In instances, piston 160 extends and retracts in response to hand crank 110, and as communicated and controlled by hydraulic fluid flow there between.

End housing and seal 158 close housing 172 at one end. End housing and seal 158 may be threaded into housing 172. End housing and seal 158 are threadably engaged to a rod end 152. Without limitation, rod end 152 comprises a spherical bearing for pivotable mounting to a vehicle chassis. Housing seal and shaft guide 166 close the housing at the opposite end. In instances, housing seal and shaft guide have a passage for shaft 156. Further, housing seal and shaft guide 166 retain shaft seal 164. Housing seal and shaft guide 166 and shaft seal 164 prevent fouling or contamination of fluid chamber 151.

Shaft 156 may comprise threaded end 157 for engagement to a chassis component, such as a control arm, a knuckle, a hub, a tie-rod, or any other suspension member, and alternatively to a subframe, frame, or unibody portion of a vehicle. In further instances, thread end 157 may engage additional rod ends or spherical bearings for mounting to chassis. Shaft 156 is fixably coupled to piston 160. The shaft 156 extends from the threaded end 157, through the housing seal and shaft guide 166 and shaft seal 164 and into the fluid chamber 151, where it engages piston 160. Piston 160 comprises at least one piston seal 170. Piston seal 170 on piston 160 splits the fluid chamber into to portions 151A, 151B. Piston seal 170 isolates each fluid chamber 151A, 151B, from the other.

Housing 172 comprises hydraulic fitting 154. Hydraulic fitting 154 may comprise any fitting known to one skilled in the art, for example AN threaded fitting (e.g. “Army-Navy” standard fittings), SAE threaded fitting (Society of Automotive Engineers), or any other known to a skilled artisan. Hydraulic fitting 154 is threaded to a housing 172 and in fluid communication with fluid chamber 151. Hydraulic fitting 154 may be threaded to housing 172 by extensions of housing 172, for example, threaded “nubs”, threaded connectors, flared and threaded line connections, or any hydraulic connection known to a skilled artisan. In certain instances, the housing 172 comprises a plurality of hydraulic fittings 154, in fluid communication with each fluid chamber 151A, 151B. Further, each hydraulic fitting 154 is in fluid communication with a hydraulic line 137, 138.

Generally speaking, the extendable rod ends may be implemented in anti-roll or sway bars to alter the lateral load transfer of the vehicle during cornering and in response to bumps. Further the extendable rod ends are configurable for suspension control arms, trailing arms, or lateral links to alter suspension geometry with respect to thrust angle, centering, track, camber, caster, and toe of the wheels with respect to the frame or body. In certain configurations the extendable rod ends may be configured as pan-hard bar, four-link suspension, three link suspension, or any other live or solid axle suspension configuration to alter the location of an axle with respect to the frame or chassis, and alter the ride height and handling of a vehicle. In certain instances, the extendable rod ends may further be configured as a tie rod to alter steering angles, toe angles, or caster. In all instances, the extendable rod ends offer driver controlled, real time or “on-the-fly” suspension adjustments.

In the preceding discussion and in the claims following, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other apparatuses, devices, components, and connections.

We claim:

1. A vehicle suspension system comprising
a driver interface;
a rear suspension; and
an extendable apparatus coupled to the suspension system and body of a vehicle, the apparatus configured to alter the suspension geometry in relation to the automobile.

2. The system of claim 1, wherein the extendable apparatus is configured to alter one vehicle suspension geometry angle chosen from the drive angle, the pinion angle, toe angle, camber angle, caster angle, or combinations thereof.

3. An extendable rod end comprising;
a first end, having a spherical bearing configured for mounting to an automotive body;
a second end, having a threaded shaft configured for mounting to an automotive rear suspension;
a extendable body positioned between the first end and the second end, configured for changing the distance along an axis extending between the first end and the second; and
a control system, in communication with an operator and the extendable body, the control system to move the extendable body in relation to operator commands.

4. The apparatus of claim 3, wherein the extendable body comprises one chosen from a hydraulic cylinder, a pneumatic cylinder, an electrical actuator, a mechanical actuator or combinations thereof.

5. The apparatus of claim 3, wherein the control system comprises one chosen from a hydraulic system, an electrical system, a mechanical system, a transmitter system, or combinations thereof.

6. A vehicle device comprising:
at least one first piston, comprising a housing and a shaft for fluid communication, wherein the shaft is configured for rotational coupling with the housing to produce linear movement of the first piston, and wherein the first piston is isolated from the from the shaft rotation; and
at least one second piston, comprising a housing and a shaft, wherein the second piston is configured for linear movement of the second piston in response to a fluid communicated from the first piston.

7. The device of claim 6, wherein the at least one first piston and the at least one second piston are in fluid communication by at least one hydraulic line.

8. The device of claim 6, wherein the at least one first piston shaft is fixably coupled to a knob.

9. The device of claim 6, wherein the at least one second piston extends between at least one vehicle suspension member and at least one chassis member.

10. The device of claim 9, wherein the at least one second piston is configured to alter the linear distance between the vehicle suspension member and the at least one chassis member.

11. The device of claim 6, wherein the at least one first piston comprises a housing, threadably sealed at one end by at least one end cap.

12. The device of claim 11, wherein the housing is threadably sealed at the opposite end by at least one threaded housing cap.

13. The device of claim 12, wherein at least one threaded housing cap is configured to interface with the at least one first piston shaft by threads to produce a linear movement of the first piston.

14. The device of claim 6 wherein the at least one first piston is isolated from the shaft rotation by a bearing.

15. The device of claim 14, wherein the bearing is retained on the shaft and coupled to the piston.
